(19) United States
(12) Patent Application Publication
(10) Pub. No.: US 2018/0288168 A1
(43) Pub. Date: Oct. 4, 2018

(54) MANAGING USER SESSIONS BASED ON CONTEXTUAL INFORMATION

(71) Applicant: Google Inc., Mountain View, CA (US)

(72) Inventors: Matthew Sharifi, Kilchberg (CH); Jakob Nicolaus Foerster, Oxford (GB)

(21) Appl. No.: 15/476,430

(22) Filed: Mar. 31, 2017

(51) Int. Cl. H04L 29/08; G06F 17/30; G06F 11/14; G06F 21/31

(52) U.S. Cl. CPC H04L 67/148; H04L 67/18; H04L 67/306; G06F 2201/84; G06F 11/1469; G06F 21/31; G06F 17/3053

(57) ABSTRACT

A method includes determining a first context of a computing device including a location of the computing device at a first time. The method includes determining a similarity score indicative of a similarity between the first context and a second context of the computing device, the second context including a location of the computing device at a second time that is earlier than the first time. The method also includes determining whether the similarity score satisfies a similarity threshold. The method further includes, responsive to determining the similarity score satisfies the similarity threshold: determining one or more applications that were executing at the second time and a respective state of each of the one or more applications at the second time; executing at least one of the one or more applications; and restoring the respective state of each of the at least one of the one or more applications.

### BACKGROUND

Computing devices (e.g., mobile phones, tablet computers, computerized watches, etc.) may be used by users in many different ways in different contexts. For example, a particular user may use a single computing device at work and at home. The user may utilize one set of applications at work and a different set of applications at home.

### SUMMARY

Techniques of this disclosure may enable a computing device to dynamically manage user sessions and applications based on a context of the computing device. The computing device may determine whether the current context of the computing device is similar to a previous context of the computing device. For example, the computing device may determine a context of the computing device based on information such as the location of the computing device, time of day, whether individuals other than the user of the computing device are nearby, etc. If the current context is similar enough to the previous context, the computing device may dynamically restore the user session for the previous context. For instance, if the user last used the computing device at home but is now using the computing device at work, the computing device may execute an application that was executing when the computing device was previously located at the user's work. In such instances, rather than simply restoring applications that were executing when the computing device was last used, the computing device may execute applications that were executing the last time the user utilized the computing device at work. In some instances, the computing device may also restore the application to the state of the application when the computing device was last located at the user's work. In this way, techniques of this disclosure may enable a computing device to dynamically change between user sessions without requiring a user to restart applications and determine where the user left off.

In one example, the disclosure describes a method that includes determining, by one or more processors, a first context of a computing device including a location of the computing device at a first time. The method includes determining, by the one or more processors, a similarity score indicative of a similarity between the first context and a second context of the computing device, the second context including a location of the computing device at a second time that is earlier than the first time. The method also includes determining, by the one or more processors, whether the similarity score satisfies a similarity threshold. The method further includes, responsive to determining the similarity score satisfies the similarity threshold: determining, by the one or more processors, one or more applications that were executing at the second time and a respective state of each of the one or more applications at the second time; executing, by the one or more processors, at least one of the one or more applications; and restoring, by the one or more processors, the respective state of each of the at least one of the one or more applications.

In another example, the disclosure describes a computing device that includes at least one processor and a memory. The memory includes instructions that, when executed by the at least one processor, cause the at least one processor to determine a first context of the computing device including a location of the computing device at a first time, and determine a similarity score indicative of a similarity between the first context and a second context of the computing device, the second context including a location of the computing device at a second time that is earlier than the first time, and determine whether the similarity score satisfies a similarity threshold. The memory includes instructions that, when executed by the at least one processor, cause the at least one processor to, responsive to determining the similarity score satisfies the similarity threshold: determine one or more applications that were executing at the second time and a respective state of each of the one or more applications at the second time; execute at least one of the one or more applications; and restore the respective state of each of the at least one of the one or more applications.

In another example, the disclosure describes a non-transitory computer-readable storage medium encoded with instructions that, when executed by at least one processor of a computing device, cause the at least one processor to determine a first context of the computing device including a location of the computing device at a first time, and determine a similarity score indicative of a similarity between the first context and a second context of the computing device, the second context including a location of the computing device at a second time that is earlier than the first time, and determine whether the similarity score satisfies a similarity threshold. The computer-readable storage medium includes additional instructions that cause the at least one processor to, responsive to determining the similarity score satisfies the similarity threshold: determine one or more applications that were executing at the second time and a respective state of each of the one or more applications at the second time; execute at least one of the one or more applications; and restore the respective state of each of the at least one of the one or more applications.

In another example, the disclosure is directed to a system including means for determining a first context of the computing device including a location of the computing device at a first time. The system includes means for determining a similarity score indicative of a similarity between the first context and a second context of the computing device, the second context including a location of the computing device at a second time that is earlier than the first time. The system also includes means for determining whether the similarity score satisfies a similarity threshold. The system further includes means for, responsive to determining the similarity score satisfies the similarity threshold: determining one or more applications that were executing at the second time and a respective state of each of the one or more applications at the second time; executing at least one of the one or more applications; and restoring the respective state of each of the at least one of the one or more applications.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device configured to dynamically select and restore user sessions, in accordance with one or more aspects of the present disclosure.

FIG. 2 is a block diagram illustrating an example computing device configured to dynamically select and restore user sessions, in accordance with one or more aspects of the present disclosure.

FIG. 3 is a block diagram illustrating an example computing device configured to dynamically select and restore user sessions and display graphical user interfaces associated with the current user session at a remote device, in accordance with one or more aspects of the present disclosure.

FIG. 4 is a conceptual diagram illustrating example details of a data structure used to store contextual information, in accordance with one or more aspects of the present disclosure.

FIG. 5 is a flowchart illustrating example operations of a computing device configured to dynamically select and restore user sessions, in accordance with one or more aspects of the present disclosure.

### DETAILED DESCRIPTION

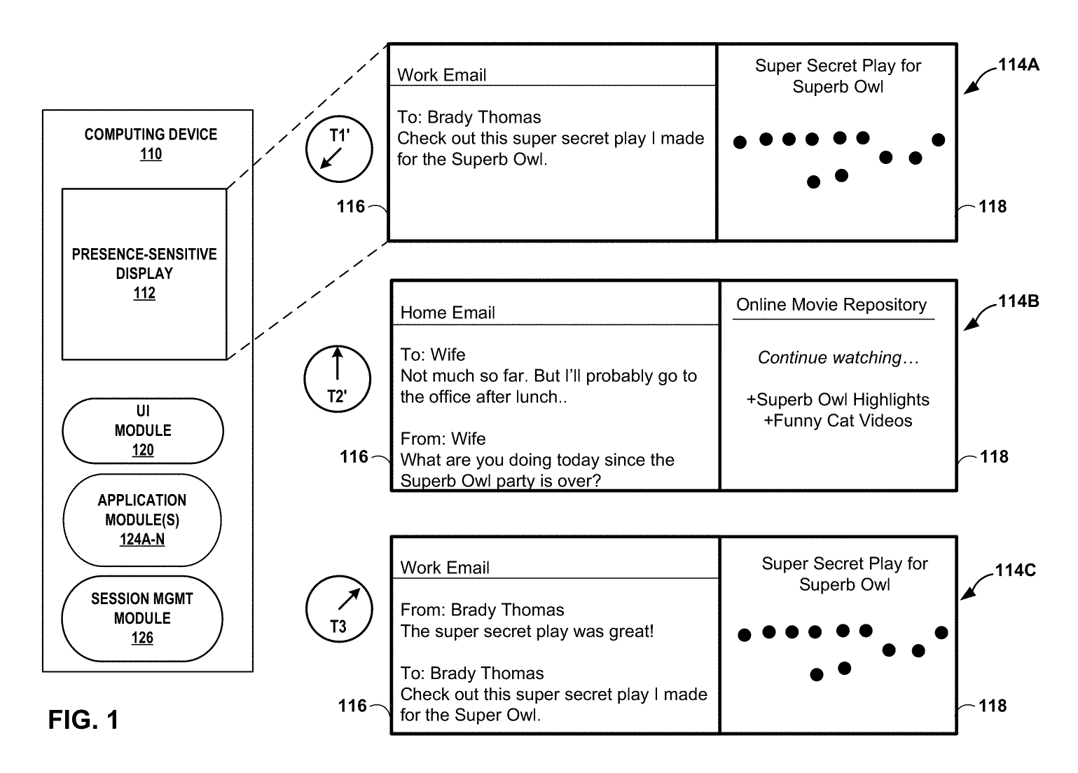

FIG. 1 is a conceptual diagram illustrating an example computing device that is configured to dynamically select and restore user sessions, in accordance with one or more aspects of the present disclosure. Computing device 110 may represent a mobile device, such as a smart phone, a tablet computer, a laptop computer, computerized watch, computerized eyewear, computerized gloves, or any other type of portable computing device. Additional examples of computing device 110 include other mobile and non-mobile devices, such as desktop computers, televisions, personal digital assistants (PDA), portable and non-portable gaming systems, digital media players or micro-consoles, e-book readers, mobile television platforms, automobile navigation and entertainment systems, vehicle cockpit displays, or any other types of wearable and non-wearable, mobile or non-mobile computing devices.

Computing device 110 includes a presence-sensitive display (PSD) 112, user interface (UI) module 120, one or more application modules 124A-N (collectively, “application modules 124”), and session management module (SMM) 126. Modules 120, 124, and 126 may perform operations described using software, hardware, firmware, or a mixture of hardware, software, and firmware residing in and/or executing at computing device 110. Computing device 110 may execute modules 120, 124, and 126 with multiple processors or multiple devices. Computing device 110 may execute modules 120, 124, and 126 as virtual machines executing on underlying hardware. Modules 120, 124, and 126 may execute as one or more services of an operating system or computing platform. Modules 120, 124, and 126 may execute as one or more executable programs at an application layer of a computing platform.

PSD 112 of computing device 110 may function as respective input and/or output devices for computing device 110. PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may receive tactile input from a user of respective computing device 110. PSD 112 may receive indications of tactile input by detecting one or more gestures from a user (e.g., the user touching or pointing to one or more locations of PSD 112 with a finger or a stylus pen). PSD 112 may output information to a user as a user interface (e.g., graphical user interface 114, which may be associated with functionality provided by computing device 110. For example, PSD 112 may present various user interfaces related to an application or other features of computing platforms, operating systems, applications, and/or services executing at or accessible from computing device 110.

UI module 120 manages user interactions with PSD 112 and other components of computing device 110. For example, UI module 120 may cause PSD 112 to display a user interface as a user of computing device 110 views output and/or provides input at PSD 112. UI module 120 may receive one or more indications of input from a user as the user interacts with the user interfaces (e.g., PSD 112). UI module 120 may interpret inputs detected at PSD 112 and may relay information about the detected inputs to one or more associated platforms, operating systems, applications, and/or services executing at computing device 110, for example, to cause computing device 110 to perform functions. For instance, UI module 120 may cause PSD 112 to display a graphical user interface.

UI module 120 may receive information and instructions from one or more associated platforms, operating systems, applications, and/or services executing at computing device 110 and/or one or more external computing systems (e.g., ISS 117). In addition, UI module 120 may act as an intermediary between the one or more associated platforms, operating systems, applications, and/or services executing at computing device 110, various output devices of computing device 110 (e.g., speakers, LED indicators, audio or electrostatic haptic output device, etc.) to produce output (e.g., a graphic, a flash of light, a sound, a haptic response, etc.) with computing device 110.

Application modules 124 represent various individual applications and services that may be executed by computing device 110. One or more application modules 124 may receive an indication of user input to select a graphical element of a user interface (e.g., graphical user interface 114) associated with a particular application module 124, and may cause computing device 110 to perform a function in response to receiving the indication of user input. Examples of application modules 124 include a mapping or navigation application, a calendar application, an assistant or prediction engine, a search application, a transportation service application (e.g., a bus or train tracking application), a social media application, a game application, an e-mail application, a messaging application, an Internet browser application, a keyboard application, or any other application that may execute at computing device 110. One or more application modules 124 may cause PSD 112 to display information associated with the respective application modules 124.

PSD 112 may output a first graphical user interface (GUI) for display at time T1, which may occur during a first user session. The first GUI may include information associated with one or more respective application modules of application modules 124. For instance, as illustrated by graphical user interface 114A, region 116 of the first GUI may include information associated with a first application module (e.g., email application module 124A) and region 118 may include information associated with a second application module (e.g., drawing application module 124B). As used herein, a particular time (e.g., when T1 is the current time) may refer to a period of time (e.g., a second, a minute, an hour, a day, etc.).

Session management module (SMM) 126 may determine a context of computing device 110 and store contextual information corresponding to the context of computing device 110. SMM 126 may only store information associated with computing device 110 and/or a user of computing device 110 if the user affirmatively consents to such collection of information. SMM 126 may further provide opportunities for the user to withdraw consent and in which case, SMM 126 may cease collecting or otherwise retaining the information associated with that particular user. SMM 126 may store the contextual information in any number of different data structures, such as a file, database, or other data structure.

As used throughout the disclosure, the term “contextual information” is used to describe information that can be used by a computing system and/or computing device, such as computing device 110 to define one or more environmental characteristics associated with computing devices and/or users of computing devices. In other words, contextual information represents any data that can be used by a computing device and/or computing system to determine a “user context” indicative of the circumstances that form the experience the user undergoes (e.g., virtual and/or physical) for a particular location at a particular time. Contextual information may include movement and position information. Movement and position information may include past, current, and future physical locations, degrees of movement, magnitudes of change associated with movement, patterns of travel, patterns of movement, elevation, etc. Contextual information may include user activity information, such as purchase histories, Internet browsing histories, search histories (e.g., internet searches, searches of computing device 110, or both), and the like. In some examples, contextual information includes local environmental conditions, such as date, time, weather conditions, traffic conditions, or the like. Contextual information may also include communication information such as information derived from e-mail messages, text messages, voice mail messages or voice conversations, calendar entries, task lists, social media network related information, etc. Contextual information may include any other information about a user or computing device that can support a determination of a user context.

SMM 126 may store the contextual information at regular or irregular intervals. For instance, SMM 126 may store contextual information when the state of computing device 110 changes (e.g., an application module 124 is terminated), at regular time intervals (e.g., once every 30 minutes, every two hours, etc.), in response to receiving a user input to store the contextual information, prior to entering a sleep-mode, etc.

In some examples, at a time T1′ that is during the first user sessions and is later than time T1, computing device 110 may receive a user input to enter a sleep-mode and may store contextual information corresponding to the context of computing device 110 at time T1′. In other words, SMM 126 may determine the context of computing device 110 prior to entering the sleep-mode. SMM 126 may store contextual information including a timestamp corresponding to a time (e.g., T1′) at which computing device 110 is used, a location of computing device 110 (e.g., GPS coordinates, a type of location such as “work”) at time T1′, an indication of each application module 124 being executed by computing device 110 at time T1′, and the status of each application module 124 being executed at time T1′. For instance, at time T1′, SMM 126 may determine computing device 110 is located at the user's work, that application modules 124A and 124B are currently being executed, and may store the contextual information corresponding to the context of computing device 110.

Computing device 110 may begin a second user session and may resume one or more application modules 124 at a time T2 that is later than time T1′. For instance, the user may take computing device 110 home after work and computing device 110 may receive a user input to utilize computing device 110 (e.g., a user input to wake and/or unlock computing device 110). In some examples, at time T2, SMM 126 causes computing device 110 to resume executing all application modules 124 in the same state as the application modules were in at time T1′. In other words, computing device 110 may resume email application module 124A and drawing application module 124B, such that email application module 124A may be signed into the user's work account even though the user and computing device 110 are now located at the user's home.

In some examples, SMM 126 may determine the context of computing device 110 at time T2 (e.g., at the beginning of the second user session). In some instances, the context includes a location of computing device 110 at time T2, a day of the week and/or time of day, whether other individuals are in proximity to computing device 110, movement, or any other type of contextual information that describe the context of computing device 110 at time T2. Responsive to determining the context at time T2, SMM 126 may determine a similarity score indicative of a similarity between the context of computing device 110 at time T2 and the context of computing device 110 at time T1′. In some instances, SMM 126 may determine the similarity score is low (e.g., 20 out of 100) because the location of computing device 110 at time T2 is different than the location of computing device 110 at time T1′.

SMM 126 may compare the similarity score to a similarity threshold (e.g., 60 out of 100). In these examples, because the similarity score is less than the threshold similarity, SMM 126 may determine the similarity score does not satisfy the threshold, which may indicate the user is likely to utilize the computing device 110 during the second user session differently than the user utilized computing device 110 during the first user session. Thus, in some examples, when the similarity score does not satisfy the similarity threshold, computing device 110 may refrain from restoring computing device 110 to the state which existed at time T1′.

During the second user session, computing device 110 may receive user inputs to execute email application module 124A and video application module 124C. Computing device 110 may receive user inputs to log in to a particular email account (e.g., a home email) associated with email application module 124A. As illustrated by graphical user interface 114B, computing device may display a second GUI that includes information associated with email application module 124A at region 116 and information associated with a third application module (e.g., video application module 124C) at region 118.

At a time T2′ that occurs during the second user session and that is after time T2, SMM 126 may determine the context of computing device 110 and may store contextual information corresponding to the context of computing device 110 at time T2′. The contextual information may include an indication of the current time (e.g., a timestamp at time T2′) and the location of computing device 110 at time T2′. The contextual information may also include an indication of which application modules 124 are executing at time T2′, and the state of each application module 124 that is executing at time T2′. For example, SMM 126 may determine email application module 124A is executing and is signed into a home email account, and that video application module 124C is also executing. Responsive to determining the context at time T2′, SMM 126 may store the contextual information corresponding to the context at time T2′.

Computing device 110 may receive a user input to wake, unlock, or otherwise continue operating at a third time T3 that is later than time T2′ and T1′ and that is part of a third user session. Rather than resuming activities that were active at time T2′, techniques of this disclosure may enable computing device 110 to restore computing device 110 to a state that existed at a time when the context of computing device 110 was similar to the current context. For example, SMM 126 may determine the context of computing device 110 at time T3, determine a similarity score between the context at time T3 and the context at a previous time (e.g., T1′ or T2′), determine whether the similarity score satisfies (e.g., is greater than or equal to) a similarity threshold, and if so, determine one or application modules that were executing at the previous time and re-execute at least one of the application modules that were executing at the previous time.

At time T3, which is later than times T1′ and T2′, SMM 126 may determine a context, including location, of computing device 110. In some instances, the context includes a day of the week and/or time of day, whether other individuals are in proximity to computing device 110, movement, or any other type of contextual information.

Responsive to determining the context at time T3, SMM 126 may determine a similarity score indicative of a similarity between the context of computing device 110 at time T3 and the context of computing device 110 at a previous time, such as time T2′ or time T1′. For example, SMM 126 may determine a first similarity score indicative of the similarity between the context of computing device at times T3 and T2′. When computing device 110 was located at the user's home at time T2′ and computing device 110 is located at the user's work at time T3, SMM 126 may assign a relatively low (e.g., 20 out of 100) value to the first similarity score. SMM 126 may compare the first similarity score to a similarity threshold (e.g., 60 out of 100). In these examples, because the first similarity score is less than the threshold similarity, SMM 126 may determine the first similarity score does not satisfy the threshold, which may indicate the user is likely to utilize the computing device 110 at time T3 differently than the user utilized computing device 110 at time T2′.

Additionally or alternatively, SMM 126 may determine a second similarity score indicative of a similarity between the context of computing device 110 at time T3 and the context of computing device 110 at time T1′. Because computing device 110 was located at the same location (e.g., the user's work) at both time T1′ and time T3, SMM 126 may determine the second similarity score is relatively large (e.g., 70 out of 100). SMM 126 may determine whether the second similarity score satisfies the similarity threshold. In these examples, SMM 126 may determine the second similarity score satisfies the similarity threshold because the second similarity score is greater than the similarity threshold.

Responsive to determining a similarity score (e.g., the second similarity score) satisfies the similarity threshold, SMM 126 may determine one or more application modules 124 that were executing at time T2′ and a respective state of each of the one or more application modules 124 at time T2′. For example, SMM 126 may query the contextual information to determine which application modules 124 were executing at time T1′. For instance, SMM 126 may determine based on the query results, that email application module 124A and drawing application module 124B were executing at time T1′.

In some examples, SMM 126 queries the contextual information to determine the respective state of each application module 124 running at time T1′. In some examples, the state of a particular application module (e.g., email application module 124A) may include whether email application module 124A was running in the foreground or background, whether a graphical element (e.g., a window) associated with email application module 124A was minimized or visible, which account was signed into email application module 124, what information for the email application module 124 is displayed (e.g., inbox, sent, drafts, etc.), or any other information about the status of email application module 124A at time T1′.

Responsive to determining which application modules 124 were executing at time T1′ and determining the respective state of each of those application modules at time T1′, SMM 126 may cause computing device 110 to execute each application module 124 that was executing at time T1′ and restore each application module 124 that was running to its previous state. In some instances, as illustrated by graphical user interface 114C, SMM 126 causes computing device 110 to execute email application module 124A and drawing application module 124B. SMM 126 may also restore email application module 124A to the same state as the email application module 124A was at time T1′ by signing into the user's work email account. In other words, in some instances, an application module (e.g., email application module 124A) may have been executing at the most recent time (e.g., T2′) computing device 110 was in use and at a previous time T1′, such that SMM 126 may cause computing device 110 to continue executing email application 124A and may update the state of email application module 124A to the state that existed at previous time T1′. In some examples, SMM 126 may also restore email application module 124A by causing PSD 112 to display a graphical element associated with email application module 124A at the same region 116 as displayed at time T1′. Similarly, SMM 126 may also restore drawing application module 124B by causing PSD 112 to display the same information (e.g., “Super Secret Play for Superb Owl”) as was displayed at time T1′.

At time T3, SMM 126 may update the state of one or more application modules 124 that were executing at time T2′ but were not executing at time T1′. For example, when restoring one or more application modules 124 to the state which they existed at time T1′, SMM 126 may determine that video application module 124C was not executing at time T1′ and may update the state of video application module 124C. In some instances, SMM 126 may updated the state of video application module 124C by suppressing one or more activities associated with video application module 124C. For instance, SMM 126 may cause PSD 112 to minimize a graphical element (e.g., a window) associated with application module 124C, cause UI module 120 to refrain from outputting audio data associated with video application module 124C, cause computing device 110 to cease executing video application module 124C, etc.

In this way, techniques of this disclosure may enable a computing device to dynamically change user sessions. The computing device 110 may dynamically change user sessions by executing application modules that were executing at a time when the context of the computing device was similar to the current context of the computing device, and by restoring the status of those application modules. By executing and restoring the status of application modules to the status when the context was similar, computing device 110 may restore applications more quickly, which may improve performance of the computing device. Further, by automatically restoring user sessions, computing device 110 may reduce the number of inputs received to restore the user session, such that computing device may execute fewer operations and consume less electrical power.

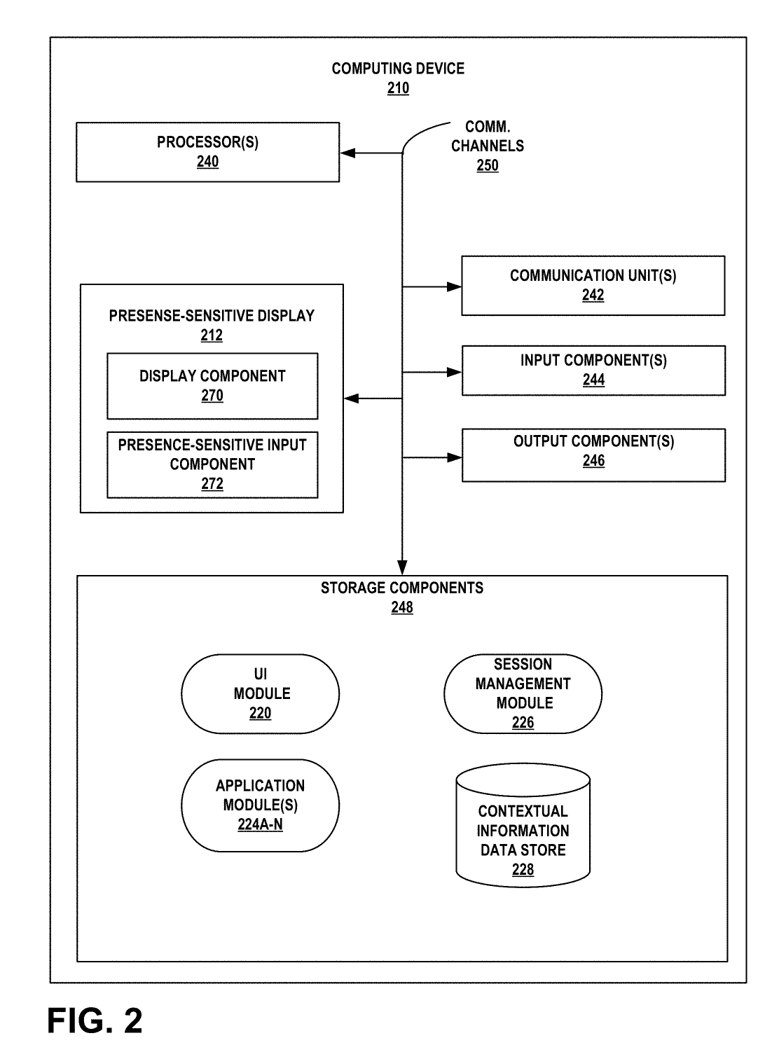

FIG. 2 is a block diagram illustrating an example computing device configured to dynamically select and restore user sessions, in accordance with one or more aspects of the present disclosure. Computing device 210 of FIG. 2 is described below as an example of computing device 110 illustrated in FIG. 1. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes presence-sensitive display 212, one or more processors 240, one or more communication units 242, one or more input components 244, one or more output components 246, and one or more storage components 248. Presence-sensitive display 212 includes display component 270 and presence-sensitive input component 272. Storage components 248 of computing device 210 may include UI module 220, one or more application modules 224A-N (collectively, “application modules 224”), SMM 226, and contextual information data store 228.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive display, touch-sensitive screen, mouse, keyboard, voice responsive system, video camera, microphone, or any other type of device for detecting input from a human or machine. In some examples, input components 244 may include one or more sensor components, such as one or more location sensors (e.g., GPS components, WiFi® components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output components 246 of computing device 210 may generate output. Examples of output are tactile, audio, and video output. Output components 246 of computing device 210 may include a presence-sensitive display, sound card, video graphics adapter card, speaker, cathode ray tube (CRT) monitor, liquid crystal display (LCD), or any other type of device for generating output to a human or machine.

Presence-sensitive display 212 of computing device 210 includes display component 270 and presence-sensitive input component 272. Display component 270 may be a screen at which information is displayed by presence-sensitive display 212. Presence-sensitive input component 272 may detect an object at and/or near display component 270. As one example range, presence-sensitive input component 272 may detect an object, such as a finger or stylus that is within two inches or less of display component 270. Presence-sensitive input component 272 may determine a location (e.g., an (x,y) coordinate) of display component 270 at which the object was detected. In another example range, presence-sensitive input component 272 may detect an object six inches or less from display component 270 and other ranges are also possible. Presence-sensitive input component 272 may determine the location of display component 270 selected by a user's finger using capacitive, inductive, and/or optical recognition techniques.

In some examples, presence-sensitive input component 272 also provides output to a user using tactile, audio, or video stimuli as described with respect to display component 270. In the example of FIG. 2, presence-sensitive display 212 displays a graphical user interface. While illustrated as an internal component of computing device 210, presence-sensitive display 212 may also represent an external component that shares a data path with computing device 210 for transmitting and/or receiving input and output. For instance, in one example, presence-sensitive display 212 represents a built-in component of computing device 210 located within and physically connected to the external packaging of computing device 210 (e.g., a screen on a mobile phone). In another example, presence-sensitive display 212 represents an external component of computing device 210 located outside and physically separated from the packaging of computing device 210 (e.g., a monitor, a projector, etc. that shares a wired and/or wireless data path with a tablet computer).

One or more processors 240 may implement functionality and/or execute instructions within computing device 210. For example, processors 240 on computing device 210 may receive and execute instructions stored by storage components 248 that execute the functionality of modules 220, 224, and 226. The instructions executed by processors 240 may cause computing device 210 to store information within storage components 248 during program execution. Examples of processors 240 include application processors, display controllers, sensor hubs, and any other hardware configure to function as a processing unit. Modules 220, 224, and 226 may be operable by processors 240 to perform various actions, operations, or functions of computing device 210. For examples, processors 240 of computing device 210 may retrieve and execute instructions stored by storage devices 248 that cause processors 240 to perform the operations of modules 220, 224, and 226. The instructions, when executed by processors 240, may cause computing device 210 to store information within storage devices 248.

One or more storage components 248 within computing device 210 may store information for processing during operation of computing device 210 (e.g., computing device 210 may store data accessed by modules 220, 224, and 226 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 may be configured to store larger amounts of information than volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 224, and 226, as well as data store 228.

Application modules 224 may include the functionality of application modules 124 of computing device 110 of FIG. 1 and may perform similar operations as application modules 124. A user of computing device 210 may interact with an interface (e.g., a graphical user interface) associated with one or more application modules 224 to cause computing device 210 to perform a function.

UI module 220 may include the functionality of UI module 120 of computing device 110 of FIG. 1 and may perform similar operations as UI module 120. For example, UI module 220 may receive information from application modules 224 that includes instructions for outputting (e.g., displaying or playing audio) a user interface (e.g., graphical user interface 114A of FIG. 1). For instance, at a first time T1 that occurs during a first user session, UI module 220 may generate a user interface and may transmit a user interface and associated data over communication channels 250 to cause PSD 212 to display a graphical user interface that includes information associated with one or more application modules 224.

SMM 226 may include the functionality of SMM 126 of computing device 110 of FIG. 1 and may perform similar operations as SMM 126 for managing user sessions. For instance, SMM 226 may determine the current context of computing device 210 at a particular time and may store contextual information corresponding to the current context at the particular time. SMM 226 may store contextual information indicative of the current context of computing device 210 in contextual information data store 228. SMM 226 may store the contextual information only if the user affirmatively consents to storing such data and may cease collecting and storing contextual information in response to the user withdrawing consent. Contextual information data store 228 may include one or more files, tables, or databases that store contextual information.

In some examples, SMM 226 may determine the current context in response to receiving a user input to lock computing device 210 or to enter a sleep-mode. For example, at time T1′, which occurs during the first user session and after time T1, computing device 210 may detect a user input to enter a sleep-mode and send an indication of the user input to UI module 220, which may cause SMM 226 to determine the current context and store contextual information corresponding to the current context prior to entering the sleep-mode.

At time T1′, SMM 226 may determine a context of computing device 210, which may include the location of computing device 210 at time T1′. SMM 226 may determine the location based on information from one or more input components (e.g., location information from GPS sensors) or one or more communication units (e.g., IP address information from a wireless radio). SMM 226 may determine a specific location (e.g., specific GPS coordinates or a specific place, such as “home” or “work”) and/or a type of location (e.g., public or private, park, library, coffee-shop, etc.). The context of computing device 210 may include the current date, time, the time of day, and/or day of the week. The context may include whether individuals (e.g., individuals not associated with the currently active user account) are proximate to computing device 210. For instance, computing device 110 may be configured with one or more user accounts, where a particular user account from the one or more configured user accounts may be active at a particular time such as time T1′, where individuals that do not correspond to the currently active user account are referred to as unauthorized individuals. The context of computing device 210 at time T1′ may also include which application modules are currently executing at time T1′, the current state of the application modules that are executing at time T1′, and any other information about the current context of computing device 210. In some examples, SMM 226 may determine that, at time T1′, computing device 210 is located at the user's work, the time of day is 5 pm, and the day of the week is a weekday (e.g., Monday). SMM 226 may determine that which application modules 224 are currently executing at T1′ and the state of each application module that is currently executing at time T1′. For instance, SMM 226 may determine that email application module 224A is current executing at time T1′ and the state of email application 224A is such that email application module 224A is signed into the user's work email account. In response to determining the current context at time T1′, SMM 226 may store contextual information corresponding to the context during a first user session.

In some examples, after locking computing device 210 or entering a sleep mode, computing device 210 may receive a user input (e.g., voice or touch input) to unlock or wake computing device 210 (e.g., to begin a second user session). UI module 220 may determine the user input corresponds to a command to unlock or wake computing device 210 and may send an indication of the command to SMM 226. For example, at time T2, computing device 210 may receive a user input to unlock computing device 210 and SMM 226 may determine the context of computing device at a time T2 in response to receiving the user input to unlock computing device 210. For instance, SMM 226 may determine the context of computing device 210 indicates computing device 210 is located at the user's home, that the time of day is 6 pm, and the day of the week is still Monday.

Responsive to determining the context of computing device at time T2, computing device 210 may query contextual information data store 228 to determine a similarity score indicative of a similarity between the context at time T1′ and the current context at time T2. SMM 226 may determine the similarity score based on one or more portions of contextual information. In some examples, SMM 226 may determine the similarity score based at least in part on the location of computing device 210 at the various times (e.g., T1′ and T2), time of day, day of the week, etc. In examples where SMM 226 determines the similarity score based only on location, SMM 226 may assign a low (e.g., 0 out of 100) value to the similarity score because the contextual information indicates that computing device 210 was located at the user's work at time T1′ and the user's home at time T2. In another example, where SMM 226 determines the similarity score based on location and day of the week, SMM 226 may assign a higher (e.g., 25 out of 100) value to the similarity score because the contextual information indicates the day of the week is the same at times T1′ and T2 even though the location of computing device 210 at times T1′ and T2 is different.

SMM 226 may compare the similarity score indicative of the similarity in contexts at times T1′ and T2 to a similarity threshold (e.g., 60 out of 100, 75 out of 100, etc.) to determine whether the similarity score satisfies (e.g., is greater than) the similarity threshold. In examples where the similarity score equals 25 out of 100 and the similarity threshold equals 65 out of 100, SMM 226 determines the similarity score does not satisfy the similarity threshold. In response to determining the similarity score does not satisfy the similarity threshold, SMM 226 may refrain from restoring computing device 210 to the state of computing device 210 at time T2. For instance, SMM 226 may cause computing device 210 to pause media that may have been playing at time T1′, minimize windows for application modules 224 or cease executing application modules 224, or otherwise refrain from resuming one or more activities and/or applications to the same state as existed at time T1′.

After unlocking computing device 210 at time T2, computing device 210 may detect one or more user inputs to execute one or more application modules 224, some of which may or may not have been executing at time T1′. In some examples, computing device 210 may detect user inputs to cause an application module of application modules 224 (e.g., email application module 224A) to resume a previous state or may cause the particular application module be in a new, different state. For example, if the state of email application module 224A at time T1′ was such that email application module 224A was signed into the user's work email account at work, the user input may cause email application to sign into a different (e.g., home) account at home. Computing device 210 may detect a user input to execute an application (e.g., media player application module 224C) that was not executing at time T1′. However, in some instances, computing device 210 may receive user inputs to re-execute an application module of application modules 224 and, optionally, to restore the application module to the state existing at time T1′ (e.g., by resuming a media file at the same spot, restoring an internet browser to a particular webpage, re-opening a particular word processing file with a word processor, etc.)

At a later time T2′ during the second user session, SMM 226 may determine the context of computing device 210 and may store contextual information indicative of the context at time T2′ to contextual information data store 228. For example, PSD 212 may detect a user input to enter a sleep-mode and may send information about the user input (e.g., x,y coordinates) to UI module 220. UI module 220 may determine that the user input corresponds to a command to enter a sleep-mode and may cause SMM 226 to determine the current context prior to entering the sleep-mode. Thus, SMM 226 may determine the current context of computing device 210, and store contextual information to contextual information data store 228. For example, SMM 226 may store the current location of computing device 210, the date and time, which application modules 224 are currently executing, and the current state of each respective application module 224 that is currently executing. In some examples, computing device 210 may enter a sleep-mode in response to receiving a user input to enter a sleep-mode and storing contextual information for time T2′.

Computing device 210 may begin a third user session at time T3. For example, computing device 210 may begin the third user session in response to receiving a user input to unlock or wake computing device 210. SMM 226 may determine a context of computing device 210 at time T3 in a similar manner as described above. In some examples, SMM 226 may determine a similarity score indicative of a similarity between the context of computing device 210 at time T3 and the context of computing device 210 at one or more respective times (e.g., T1′ and T2′). For example, SMM 226 may determine a respective similarity score for each session that is associated with the currently active user account and is stored within contextual information data store 228. In other words, contextual information data store 228 may store contextual information for different users and may determine a set of similarity scores indicative of a similarity between the current context at time T3 and previous contexts (e.g., at times T2′ and T1′) at which the currently active user account was signed into computing device 210. SMM 226 may determine a set of similarity scores that includes a first similarity score indicative of a similarity between the context at time T3 and the context at time T1′, and a second similarity score indicative of a similarity between the context at time T3 and the context at time T2′. For example, where the context of computing device 210 includes the current location of computing device 210, SMM 226 may determine the location at time T3 is at the user's work. SMM 226 may determine that the first similarity score is relatively high (e.g., 80 out of 100) because the location of computing device at time T3 is the same as the location of computing device at time T1′ and that the second similarity score is relatively low (e.g., 10 out of 100) because the location of computing device at time T3 is different than the location of computing device at time T2′.

SMM 226 may determine, for each similarity score, whether the respective similarity scores satisfy (e.g., is greater than or equal to) a similarity threshold. For instance, when the similarity threshold equals 50 out of 100, SMM 226 may determine that the first similarity score satisfies the similarity threshold and that the second similarity score does not satisfy the similarity threshold. In these examples, because the first similarity score is the only similarity score that satisfies the similarity threshold, SMM 226 may determine that the context of computing device 210 at time T3 is most similar to the context of computing device at time T1′ and may determine to restore one or more application modules 224 to the state existing at time T1′.

In some examples, at time T3, SMM 226 may determine that a plurality of similarity scores satisfy the similarity threshold, which may indicate that the current context of computing device 210 is similar to the context of computing device 210 at a plurality of prior times (e.g., times prior to T3). For example, if the similarity threshold equals 60 out of 100, the first similarity score indicative of the similarity in contexts between T1′ and T3 equals 80 out of 100, and the second similarity score indicative of the similarity in contexts between T2′ and T3 equals 70 out of 100, SMM 226 may determine that both the first and second similarity scores satisfy the similarity threshold, which may indicate that the current context is similar to the context at time T1′ and the context at time T2′.

SMM 226 may select a particular context from the plurality contexts in order to determine the time (e.g., T1′ or T2′) from which one or more application modules 224 should be restored. In other words, SMM 226 may select a previous context that is similar to the current context and restore one or more application modules 224 to the state that existed during the previous context. SMM 226 may select the previous context (e.g., at time T1′ or T2′) based on the respective similarity scores of the plurality of similarity scores that satisfy the similarity threshold. In some examples, SMM 226 may select the most recent context where the corresponding similarity score satisfies the similarity threshold. For example, when the first similarity score (e.g., indicative of the similarity to time T1′) and second similarity score (e.g., indicative of the similarity to time T2′) satisfy the similarity threshold, SMM 226 may the T2′ occurred more recently than time T1′ and may select the context at time T2′ as the particular context for which to restore one or more application modules 224. In some instances, SMM 226 selects the context corresponding to the largest similarity score from the plurality of similarity scores that satisfy similarity threshold. For instance, SMM 226 may determine that the first similarity score corresponding to T1′ and T3 is greater than the second similarity score corresponding to T2′ and T3, and may select the context at time T1′ as the particular context for which to restore one or more application modules 224.

Responsive to determining the similarity score for a particular context (e.g., the context at time T1′) satisfies the similarity threshold and selecting the particular context, SMM 226 may determine one or more application modules 224 that were executing at time T1′ and the respective state of each of the one or more application modules 224 at time T1′. For example, SMM 226 may query contextual information data store 228 to determine which application modules 224 were executing at time T1′ and the respective state of each application module 224 executing at time T1′ (e.g., email application module 224A and internet browser application module 224B). The state of a particular application module may include whether the application module was running in the foreground or background, whether a graphical element (e.g., a window) associated with email application module 224A was minimized or visible, which account was signed into email application module 224, a web-address displayed by browser application module 224B, or any other information about the state of application modules 224A and 224B at time T1′.

In some examples, at time T3, SMM 226 may update the state of an application module (e.g., email application module 224A) from a state existing when computing device was most recently used (e.g., time T2′) to a state that existed at the earlier time T1′. For instance, email application module 224A may have been logged into a user's home account at time T2′, and at time T3, SMM 226 may restore the state of email application module 224A to be the same state as existed at time T1′ by logging out of the user's home account and signing into the user's work account. In some examples, at least one of the one or more application modules that are restored at time T3 may not have been executing at a time between time T1′ and time T3. For instance, SMM 226 may determine that internet browser application module 224B was executing at time T1′ and may restore internet browser application module 224B to the state existing at time T1′, even though internet browser application module 224B was not executing at a time between T1′ and T3 (e.g., internet browser application module 224B was not executing at time T2).

In some examples, SMM 226A may determine one or more activities associated with one or more application modules 224 that were executing at a time between the time corresponding to the selected context and the current time T3 and that were not executing at the at the time corresponding to the selected context. In other words, if the selected context corresponds to time T1′, SMM 226 may determine one or more activities associated with (e.g., activities that were being performed by) one or more application modules 224 at time T2′ but were not associated with one or application modules 224 at the earlier time T1′. Said another way, if computing device 210 was most recently used at the user's home at time T2, and SMM 226 determines to restore one or more application modules 224 to a state existing at time T1′, SMM 226 may determine one or more activities that were being performed by one or more application modules 224 at the most recent time T2 that computing device 210 was used and that were not being performed at time T1′. Thus, SMM 226 may cause computing device 210 to suppress at least one of the one or more activities that were associated with one or more applications 224 at time T2′ and were not associated with one or more applications at time T1′.

Computing device 210 may suppress a particular activity by ceasing execution of the activity, such as a particular application module 224. Computing device 210 may suppress an activity by refraining from outputting information associated with a particular application module (e.g., media player application module 224C). For instance, computing device 210 may refrain from outputting a graphical user interface associated with media player application module 224C (e.g., by minimizing or closing a window for module 224C) or from outputting audio data associated with media player application module 224C (e.g., by muting a speaker or pausing playback of a media file). In some examples, computing device 210 may suppress an activity by closing a particular data file or internet browser tab, logging out of a particular user account associated with a particular application module, etc.

Computing device 210 may, prior to restoring one or more application modules 224 and/or suppressing one or more activities, output an indication the one or more application modules 224 to be restored and, optionally, the respective states for each of the one or more application modules. For example, SMM 226 may send an indication (e.g., a name or other identifier) of each application module 224 to be restored to UI module 220. UI module 220 may generate a graphical user interface that includes the names of each application module 224 to be restored and may enable a user to select one or more of the application modules 224 for restoration. Similarly, SMM 226 may send an indication of one or more activities to be suppressed to UI module 220, which may generate a graphical user interface including the names of the activities to be suppressed in order to enable a user to select one or more of the activities performed by the application modules to be suppressed. Responsive to generating the graphical user interface that identifies the one or more applications to be restored and/or one or more activities to be suppressed, UI module 220 may output the graphical user interface to PSD 212 for display. For instance, SMM 226 may determine one or more application modules 224 to be restored and/or activities to be suppressed in response to receiving a user input to unlock or wake computing device 210, and may cause PSD 212 to display, prior to unlocking or waking computing device 210, the graphical user interface enabling the user to select which application modules 224 are restored and/or which activities performed by the application modules will be suppressed. Thus, in some examples, SMM 226 may only execute and restore a particular application and/or suppress an activity at time T3 in response to receiving a user input selecting the particular application module for restoration and/or selecting an activity for suppression.

SMM 226 may determine a context of computing device 210 while computing device 210 is in use. SMM 226 may determine the context at regular time intervals (e.g., every 15 minutes), when an application module 224 is initially executed or ceases being executed, in response to detecting an unauthorized individual (e.g., an individual not currently associated with the currently active user account) proximate to computing device 210, etc. For example, computing device 210 may be located at the user's work at a time T4 that occurs during the third user session and after time T3. At time T4, computing device 210 may be executing a personal finance application module 224D when an unauthorized individual walks into the user's office. Computing device 210 may detect the presence of the unauthorized individual (e.g., based on image data generated by an image sensor). In response to detecting the unauthorized individual, SMM 226 may determine the context of computing device at time T4. For instance, SMM 226 may determine that computing device 210 is still located at the user's work and that an unauthorized individual is proximate to computing device 210.

SMM 226 may determine a similarity score indicative of a similarity between the context of computing device 210 at time T4 and the context of computing device 210 at a previous time. For instance, SMM 226 may determine a similarity score for each respective context stored in contextual information data store 228. SMM 226 may assign a high similarity score to previous contexts where computing device 210 is located at the user's work and unauthorized individuals are proximate to computing device 210. SMM 226 may determine whether any of the similarity score satisfies a similarity threshold and if so, may select a context from a set of contexts corresponding to similarity scores that satisfy the threshold. For example, if two or more contexts are similar to the current context at time T4, SMM 226 may select the context corresponding to the highest similarity score, which may correspond to times when computing device 210 is located at the user's work and unauthorized individuals are proximate to computing device 210. SMM 226 may determine the state of computing device 210 at the time corresponding to the selected context and may restore one or more application modules 224 to the state existing at the time (e.g., T0) of the selected context. For example, a user may have minimized personal finance application module 224D at a previous time T0 when an unauthorized individual entered the user's office. Thus, SMM 226 may query contextual information data store 228 to determine the state of any application modules 224 executing at time T0 and may determine application module 224D was suppressed (e.g., a window representing application module 224D was minimized such that the information associated with application module 224D was not displayed by a graphical user interface). As a result, SMM 226 may update the state of personal finance application module 224D by sending a command to UI module 220 to suppress application module 224D while an unauthorized individual is proximate to computing device 210.

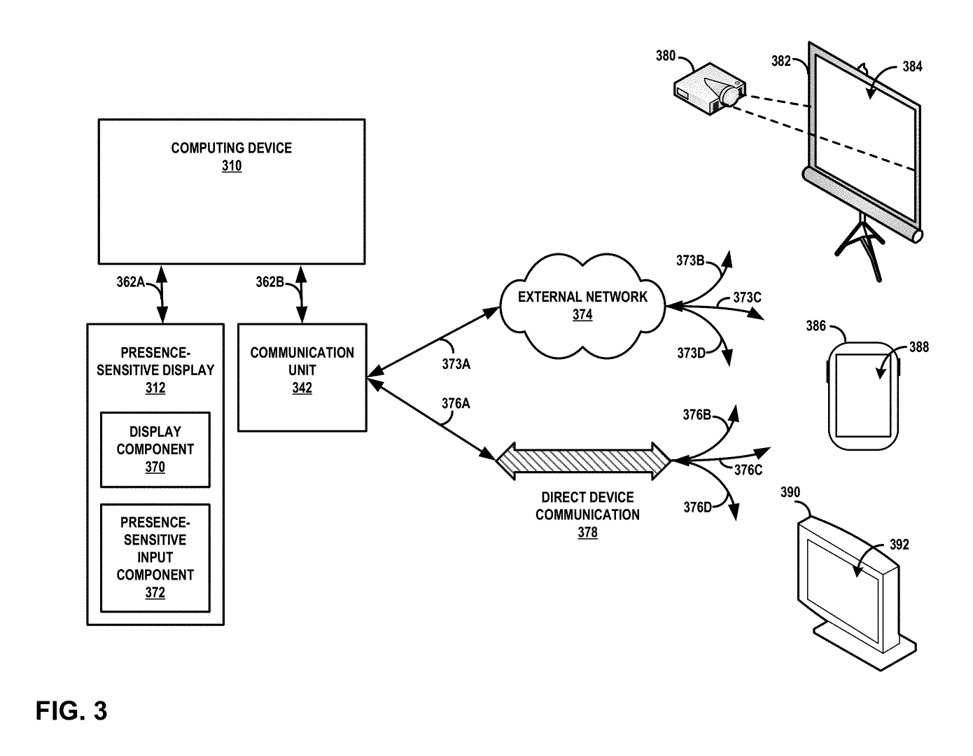

FIG. 3 is a block diagram illustrating an example computing device configured to dynamically select and restore user sessions and display graphical user interfaces associated with the current user session at a remote device, in accordance with one or more techniques of the present disclosure. Graphical content, generally, may include any visual information that may be output for display, such as text, images, and a group of moving images, to name only a few examples. The example shown in FIG. 3 includes a computing device 310, a PSD 312, communication unit 342, projector 380, projector screen 382, mobile device 386, and visual display component 390. In some examples, PSD 312 may be a presence-sensitive display as described in FIGS. 1-2. Although shown for purposes of example in FIGS. 1 and 2 as a stand-alone computing device 110 and 210 respectively, a computing device such as computing device 310 may, generally, be any component or system that includes a processor or other suitable computing environment for executing software instructions and, for example, need not include a presence-sensitive display.

As shown in the example of FIG. 3, computing device 310 may be a processor that includes functionality as described with respect to processors 240 in FIG. 2. In such examples, computing device 310 may be operatively coupled to PSD 312 by a communication channel 362A, which may be a system bus or other suitable connection. Computing device 310 may also be operatively coupled to communication unit 342, further described below, by a communication channel 362B, which may also be a system bus or other suitable connection. Although shown separately as an example in FIG. 3, computing device 310 may be operatively coupled to PSD 312 and communication unit 342 by any number of one or more communication channels.

In other examples, such as illustrated previously by computing devices 110 and 210 in FIGS. 1-2 respectively, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

PSD 312 may include display component 370 and presence-sensitive input component 372. Display component 370 may, for example, receive data from computing device 310 and display the graphical content. In some examples, presence-sensitive input component 372 may determine one or more user inputs (e.g., continuous gestures, multi-touch gestures, single-touch gestures) at PSD 312 using capacitive, inductive, and/or optical recognition techniques and send indications of such user input to computing device 310 using communication channel 362A. In some examples, presence-sensitive input component 372 may be physically positioned on top of display component 370 such that, when a user positions an input unit over a graphical element displayed by display component 370, the location at which presence-sensitive input component 372 corresponds to the location of display component 370 at which the graphical element is displayed.

As shown in FIG. 3, computing device 310 may also include and/or be operatively coupled with communication unit 342. Communication unit 342 may include functionality of communication unit 242 as described in FIG. 2. Examples of communication unit 342 may include a network interface card, an Ethernet card, an optical transceiver, a radio frequency transceiver, or any other type of device that can send and receive information. Other examples of such communication units may include Bluetooth®, cellular, and WiFi® radios, Universal Serial Bus (USB) interfaces, etc. Computing device 310 may also include and/or be operatively coupled with one or more other devices (e.g., input devices, output components, memory, storage devices) that are not shown in FIG. 3 for purposes of brevity and illustration.

FIG. 3 also illustrates a projector 380 and projector screen 382. Other such examples of projection devices may include electronic whiteboards, holographic display components, and any other suitable devices for displaying graphical content. Projector 380 and projector screen 382 may include one or more communication units that enable the respective devices to communicate with computing device 310. In some examples, the one or more communication units may enable communication between projector 380 and projector screen 382. Projector 380 may receive data from computing device 310 that includes graphical content. Projector 380, in response to receiving the data, may project the graphical content onto projector screen 382. In some examples, projector 380 may determine one or more user inputs (e.g., continuous gestures, multi-touch gestures, single-touch gestures) at projector screen using optical recognition or other suitable techniques and send indications of such user input using one or more communication units to computing device 310. In such examples, projector screen 382 may be unnecessary, and projector 380 may project graphical content on any suitable medium and detect one or more user inputs using optical recognition or other such suitable techniques.

Projector screen 382, in some examples, may include a presence-sensitive display 384. Presence-sensitive display 384 may include a subset of functionality or all of the functionality of presence-sensitive display 112, 212, and/or 312 as described in this disclosure. In some examples, presence-sensitive display 384 may include additional functionality. Projector screen 382 (e.g., an electronic whiteboard), may receive data from computing device 310 and display the graphical content. In some examples, presence-sensitive display 384 may determine one or more user inputs (e.g., continuous gestures, multi-touch gestures, single-touch gestures) at projector screen 382 using capacitive, inductive, and/or optical recognition techniques and send indications of such user input using one or more communication units to computing device 310.

FIG. 3 also illustrates mobile device 386 and visual display component 390. Mobile device 386 and visual display component 390 may each include computing and connectivity capabilities. Examples of mobile device 386 may include e-reader devices, convertible notebook devices, hybrid slate devices, etc. Examples of visual display component 390 may include other semi-stationary devices such as televisions, computer monitors, etc. As shown in FIG. 3, mobile device 386 may include a presence-sensitive display 388. Visual display component 390 may include a presence-sensitive display 392. Presence-sensitive displays 388, 392 may include a subset of functionality or all of the functionality of presence-sensitive display 112, 212, and/or 312 as described in this disclosure. In some examples, presence-sensitive displays 388, 392 may include additional functionality. In any case, presence-sensitive display 392, for example, may receive data from computing device 310 and display the graphical content. In some examples, presence-sensitive display 392 may determine one or more user inputs (e.g., continuous gestures, multi-touch gestures, single-touch gestures) at projector screen using capacitive, inductive, and/or optical recognition techniques and send indications of such user input using one or more communication units to computing device 310.

As described above, in some examples, computing device 310 may output graphical content for display at PSD 312 that is coupled to computing device 310 by a system bus or other suitable communication channel. Computing device 310 may also output graphical content for display at one or more remote devices, such as projector 380, projector screen 382, mobile device 386, and visual display component 390. For instance, computing device 310 may execute one or more instructions to generate and/or modify graphical content in accordance with techniques of the present disclosure. Computing device 310 may output the data that includes the graphical content to a communication unit of computing device 310, such as communication unit 342. Communication unit 342 may send the data to one or more of the remote devices, such as projector 380, projector screen 382, mobile device 386, and/or visual display component 390. In this way, computing device 310 may output the graphical content for display at one or more of the remote devices. In some examples, one or more of the remote devices may output the graphical content at a presence-sensitive display that is included in and/or operatively coupled to the respective remote devices.

In some examples, computing device 310 may not output graphical content at PSD 312 that is operatively coupled to computing device 310. In other examples, computing device 310 may output graphical content for display at both a PSD 312 that is coupled to computing device 310 by communication channel 362A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 310 and output for display at PSD 312 may be different than graphical content display output for display at one or more remote devices.

Computing device 310 may send and receive data using any suitable communication techniques. For example, computing device 310 may be operatively coupled to external network 374 using network link 373A. Each of the remote devices illustrated in FIG. 3 may be operatively coupled to network external network 374 by one of respective network links 373B, 373C, or 373D. External network 374 may include network hubs, network switches, network routers, etc., that are operatively inter-coupled thereby providing for the exchange of information between computing device 310 and the remote devices illustrated in FIG. 3. In some examples, network links 373A-373D may be Ethernet, ATM or other network connections. Such connections may be wireless and/or wired connections.

In some examples, computing device 310 may be operatively coupled to one or more of the remote devices included in FIG. 3 using direct device communication 378. Direct device communication 378 may include communications through which computing device 310 sends and receives data directly with a remote device, using wired or wireless communication. That is, in some examples of direct device communication 378, data sent by computing device 310 may not be forwarded by one or more additional devices before being received at the remote device, and vice-versa. Examples of direct device communication 378 may include Bluetooth®, Near-Field Communication, Universal Serial Bus, WiFi®, infrared, etc. One or more of the remote devices illustrated in FIG. 3 may be operatively coupled with computing device 310 by communication links 376A-376D. In some examples, communication links 376A-376D may be connections using Bluetooth®, Near-Field Communication, Universal Serial Bus, infrared, etc. Such connections may be wireless and/or wired connections.

In accordance with techniques of the disclosure, computing device 310 may dynamically manage user sessions and applications based on a context of the computing device. For example, computing device 310 may determine whether the current context of the computing device is similar to a previous context of the computing device. For instance, computing device 210 may determine the current context and determine, for one or more previous contexts, a respective similarity score indicative of a similarity between the current context and the previous context. Computing device 310 may determine whether one or more similarity scores satisfies (e.g., is greater than or equal to) a similarity threshold, which may indicate whether the current context is similar to one or more previous contexts. Responsive to determining that at least one similarity score satisfies the similarity threshold, computing device 310 may select a particular context from the contexts associated with the similarity scores that satisfy the similarity threshold. In other words, computing device 310 may select a particular context from a set of previous contexts that are similar to the current context. For example, computing device 310 may select the previous context corresponding to the most recent similarity score that satisfies the threshold, or may select the previous context correspond to the highest similarity score.

Responsive to selecting a previous context, computing device 310 may determine one or more application modules that were executing at a time corresponding to the selected context, and may determine the state of each application modules that was executing at that time. Computing device 310 may execute at least one of the application modules that was executing at the time corresponding to the selected context. Computing device 310 may further restore the state of the at least one application to the state that existed at that time. For instance, computing device 310 may execute an internet browser application module that was executing at the time of the selected context, generate a graphical user interface associated with the internet browser application, and output the graphical user interface to projector 380, projector screen 382, mobile device 386, and/or visual display component 390 for display.

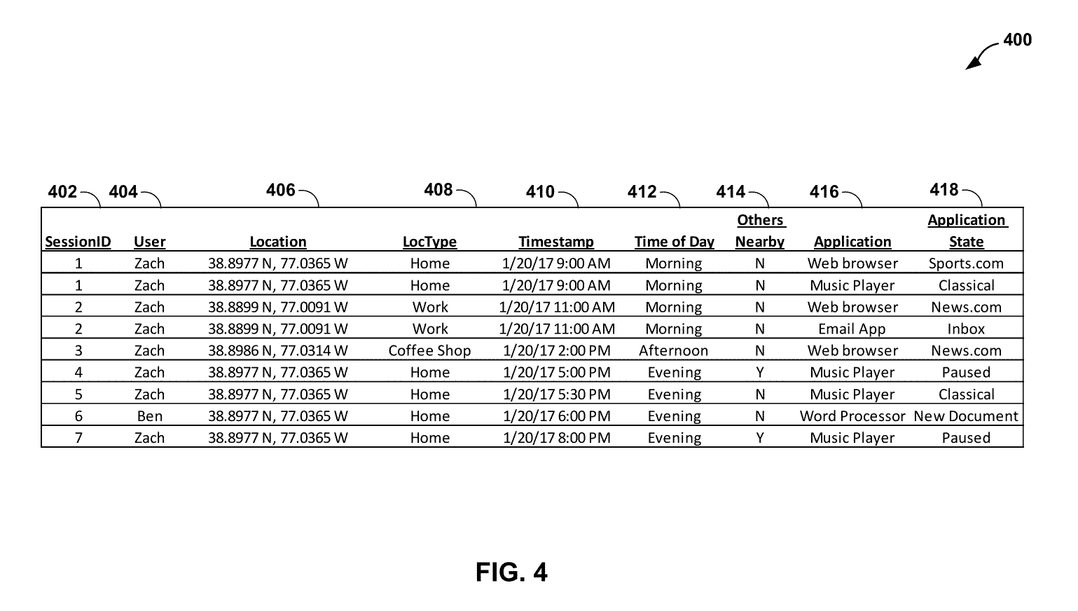

FIG. 4 is a conceptual diagram illustrating example details of a data structure used to store contextual information, in accordance with one or more aspects of the present disclosure. For ease of illustration only, the data structure will be described as contextual information table 400 of contextual information data store 228. However, the contextual information may be stored in any type of data structure. For purposes of illustration, the contextual information table 400 will be described with reference to FIGS. 1 and 2.

Contextual information table 400 may store contextual information, including N of rows of data and M columns of data for each of the N rows. In some examples, contextual information table 400 includes columns SessionID 402, User 404, Location 406, LocType 408, Timestamp 410, Time of Day 412, Others Nearby 414, Application 416, and Application State 418. However, contextual information table 400 may include additional or fewer columns.

Column SessionID 402 may identify a user session. User 404 may identify a user account logged into computing device 210 for each user session. Location 406 may include a location (e.g., GPS coordinates) of computing device 110 during each user session. Column LocType 408 may indicate the type of the location of computing device 110 during each user session. For example, the values of LocType 408 may include values such as “Home”, “Work”, “Coffee Shop”, etc. In some instances, LocType 408 may indicate whether the type of location is public or private. For instance, LocType 408 may include values such as “Public”, “Private.”

Column Timestamp 410 may include a timestamp corresponding to a time at which computing device 110 determined the contextual information for a particular user session. For instance, the timestamp of Timestamp 410 may include a date and time. In some example, column Time of Day 412 may include values that indicate a range of time corresponding to the time at which computing device 110 determined the contextual information for a user session. In other words, in contrast to Timestamp 410 which may indicate a particular time, Time of Day 412 may include values such as “Morning”, “Afternoon”, “Evening”, etc. In some examples, column Others Nearby 414 may indicate whether individuals other than an individual associated with the currently active user account (e.g., unauthorized individuals) are proximate to computing device 110.

In some examples, column Application 416 identifies one or more application executing at the time computing device 110 determined the contextual information for each respective user session. Similarly, column Application State 418 may indicate the state of each application executing at the time computing device 110 determined the contextual information for each respective user session.

In operation, computing device 110 may determine the context of computing device 110 at a particular time and may store contextual information corresponding to the respective context at the particular time. For example, computing device 110 may receive a user input to begin a user session. For instance, computing device 110 may begin a first user session in response to receiving a user input to unlock or wake computing device 110 at time T1. During the first user session, computing device 110 may execute one or more application modules 124. At a later time, T1′, computing device 110 may receive a user input to enter a sleep mode or to lock computing device 110. In some examples, in response to receiving the user input to enter a sleep mode, computing device 110 may determine the current context of computing device 110. For example, at time T1′, computing device 110 may determine that the currently active user account is “Zach” and that the computing device 110 is currently located at 38.8977 N, 77.0365 W, which may correspond to the user's home. Likewise, computing device 110 may store a timestamp indicating the current date and time at time T1′ (e.g., Jan. 20, 2017 at 9:00 a.m.) and an indication that the current time of day is “morning.” Computing device 110 may also determine that there are no individuals (e.g., other than the user associated with the currently active user account) proximate to computing device 110 at time T1′. At time T1′, computing device 110 may also determine that an internet browser (also referred to as a web browser) application module and a music player application module are currently executing at computing device 110. In some examples, computing device 110 may determine the state of the internet browser application module includes a tab opened to a particular webpage (e.g, sports.com) and the state of the music player application module includes playing classical music. Computing device 110 may store contextual information corresponding to the context of computing device 110 in contextual information table 400 and may assign a session ID value of 1 to the contextual information at time T1′.

Computing device 110 may initialize another user session at a later time. For example, computing device 110 may receive a user input to wake computing device 110 at times T2, T3, T4 and may begin a new user session (e.g., SessionIDs 2-4). At each respective time T2-T4, computing device may restore computing device 110 to a state existing during a previous user session or may refrain from restoring computing device 110 to a previous state. Computing device 110 may determine the context of computing device 110 during each respective user session. For example, at time T2′ during the second user session (e.g., SessionID equals 2), computing device may determine the context of computing device 110 (e.g., in response to receiving a user input to enter a sleep mode) and may store contextual information corresponding to the context of computing device 110 at time T2′. Similarly, at time T3′, computing device 110 may determine the context of computing device 110 and may store contextual information corresponding to times T3′ to contextual information table 400.

At time T4, computing device 110 may be located at the user's home, and may be executing a music player application module, which may be playing classical music. Computing device 110 may determine that the currently active user account (e.g., Zach) is the only individual proximate to computing device 110, in other words, there are no other individuals nearby. At time T4′, computing device 110 may determine that another individual is now proximate to computing device 110. For example, at time T4′, the user's roommate (e.g., Ben) may enter the same room as the currently active user account. In some instances, a user may change the state of a particular application when the other individual enters the room, for instance, by pausing the music player application module (e.g., in order to talk to the roommate).

In some examples, computing device 110 may determine the context of computing device 110 in response to detecting an unauthorized individual (e.g., an individual not associated with the currently active user account) is proximate to computing device 110. For example, at time T4′, computing device may determine that computing device 110 is located at the user's home, an unauthorized individual is nearby, and that the music player application module is in a paused state (e.g., is not currently playing music). Responsive to determining the context of computing device 110, computing device 110 may store contextual information corresponding to the context at time T4′ to contextual information table 400.

In some examples, at time T5, an individual associated with the currently active user account may cause the music player application module to resume playing music when an unauthorized individual is no longer proximate to computing device 110. At time T5′, computing device 110 may receive a user input to log out. Responsive to receiving the user input to log out, computing device 110 may determine the context of computing device 110 at the current time T5′, and may store contextual information corresponding to the current context at contextual information table 400. For instance, computing device 110 may store contextual information for user session 5 (e.g., SessionID equals 5) at time T5′.

At time T6, computing device 110 may receive a user input to log into a different account (e.g., Ben). In response to receiving a user input to log in to computing device 110, computing device 110 may determine the current context of computing device 110. Computing device 110 may determine a similarity score between the current context at time T6 and a respective context in a set of previous contexts. Each similarity score may indicate a similarity between the current context and a respective previous context. For instance, computing device 110 may determine a respective similarity score indicative of a similarity between the context at time T6 and the context at each of times T1′-T5′. Computing device 110 may determine whether any of the similarity scores satisfy (e.g., is greater than or equal to) a similarity threshold. In some examples, at time T6, computing device 110 may assign a low value (e.g., 10 out of 100) to each similarity score because the currently active user account (e.g., Ben) does not match the user for any of the previous contexts. Computing device 110 may compare the respective similarity scores to the similarity threshold (e.g., 50 out of 100) and determine that none of the similarity scores satisfy the similarity threshold. In response to determining none of the similarity scores satisfy the similarity threshold, computing device 110 may refrain from restoring computing device 110 to a previous user session. At time T6′, computing device may receive a user input to log out, determine the current context of computing device 110 at time T6′, and may store contextual information corresponding to the current context to contextual information table 400 (e.g., as part of user session 6).

Computing device 110 may, at time T7, begin another user session (e.g., SessionID equals 7). For example, computing device 110 may receive a user input to sign-in with a particular user (e.g., Zach). At time T7, computing device 110 may determine the current context of computing device 110. For instance, computing device 110 may determine the current date is Jan. 20, 2017, the current time is 8:00 p.m., computing device 110 is located at the user's home, and that there are no unauthorized users proximate to computing device 110. In some examples, computing device 110 may query contextual information table 400 to determine a similarity score indicative of the similarity between the context at time T7 and the context at times T1′-T6′, which may correspond to the times when computing device previously stored contextual information for SessionIDs 1-6. In these examples, computing device may determine six similarity scores (e.g., indicative of a similarity between context at times T7 and T1′, T7 and T2′, and so on to T7 and T6′).

In some examples, computing device 110 may assign a medium value (e.g. 60 out of 100) to the similarity score indicative of the similarity between the context at times T7 and T1′ because the location is the same but the time of day is different. In response to querying contextual information table 400, computing device 110 may assign a relatively high value (e.g., 70 out of 100) to the similarity score indicative of the similarity between the context at times T7 and T5′ because the location of computing device 110 was located at the user's home at both times, the time of day is “evening” for both times. Similarly, computing device 110 may assign a relatively high value (e.g., 80 out of 100) to the similarity score indicative of the similarity between the context at times T7 and T4′ because the location of computing device 110 was located at the user's home at both times, the time of day is “evening” for both times, and there was an unauthorized individual proximate to computing device 110 at both times T7 and T4′. In contrast, computing device 110 may assign relatively lower values to the similarity scores indicative of the similarity in context at times T7 and T2′ (e.g., 10 out of 100), T7 and T3′ (e.g., 25 out of 100), and T7 and T6′ (e.g., 10 out of 100).

Computing device 110 may compare the similarity scores to a similarity threshold (e.g., 50 out of 100) and may determine that the similarity scores corresponding to previous times T1′, T4′ and T5′ satisfy (e.g., are greater than or equal to) the similarity threshold. Computing device 110 may select a context corresponding to the similarity scores that satisfy the similarity threshold and restore one or more application modules to the state that existed at the time of the selected context. In some examples, computing device 110 selects the most recent context that corresponds to a similarity score that satisfies the similarity threshold. In such an example, computing device 110 may select the context corresponding to time T5′ (e.g., SessionID equals 5) because T5′ is the most recent time where the corresponding similarity score satisfies the similarity threshold. In some instances, computing device 110 select the context corresponding to the highest similarity score that also satisfies the similarity threshold. In such instances, computing device 110 may select the context corresponding to time T4′ (e.g., SessionID equals 4) because previous time T4′ corresponds to the highest similarity score.

Responsive to selecting a context, computing device 110 may determine one or more applications that were executing at the time of the selected context. For example, when computing device 110 selects the context where SessionID=4 (e.g., corresponding to time T4′), computing device 110 may query contextual information table 400 and determine that the music player application module was executing at time T4′ and that the music player application module was in a paused state at time T4′. Thus, at time T7, computing device 110 may execute the music player application module and may restore the state to a paused state. At a later time T7′, computing device 110 may receive a user input end the seventh user session (e.g., by receiving a user input to enter a sleep mode or lock computing device 110), determine the context of computing device 110 at time T7′, and store contextual information corresponding to the context at time T7′ to contextual information table 400.

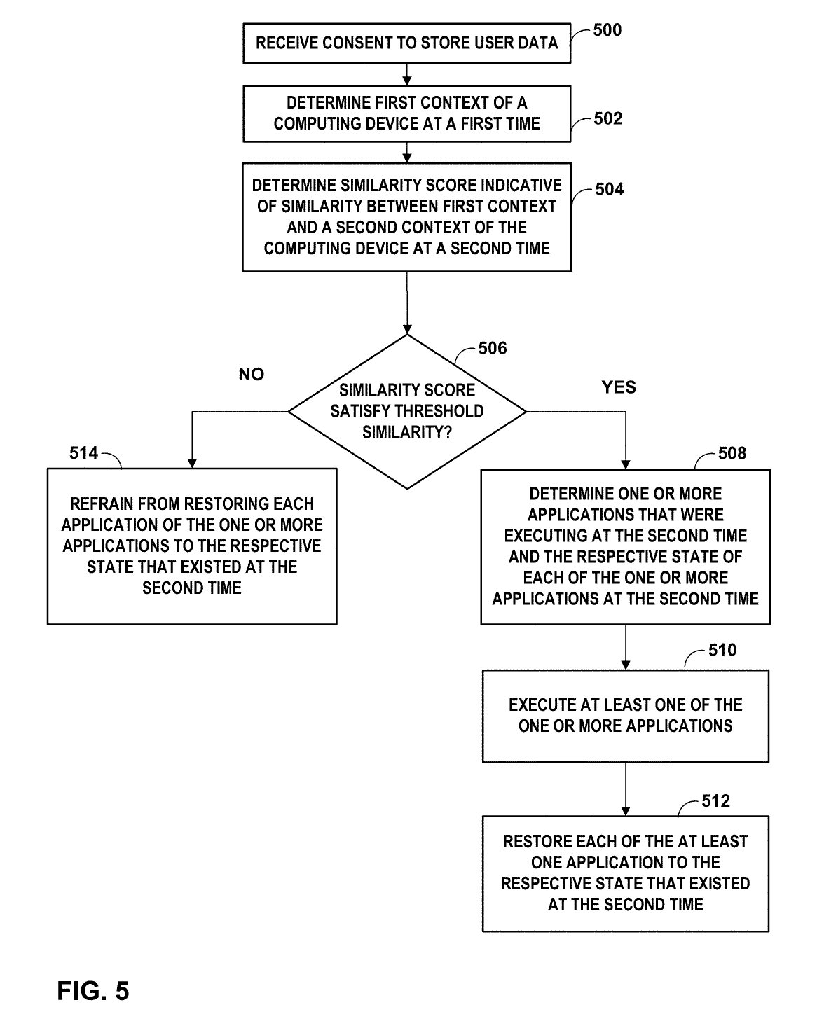

FIG. 5 is a flowchart illustrating an example operation of the computing device configured to dynamically generate and display customized onboarding tutorials, in accordance with one or more aspects of the present disclosure. The process of FIG. 5 may be performed by one or more processors of a computing device, such as computing devices 110 and 210 as illustrated in FIG. 1 and FIG. 2, respectively. For purposes of illustration only, FIG. 5 is described below within the context of computing device 110 and 210 of FIG. 1 and FIG. 2, respectively.

Computing device 110 may receive consent to store user data (500). Computing device 110 may only store information associated with a user of computing device 110 if the user affirmatively consents to such collection of information. Computing device 110 may further provide opportunities for the user to withdraw consent and in which case, computing device 110 may cease collecting or otherwise retaining the information associated with that particular user. Responsive to receiving user consent to store user data, computing device 110 may store contextual information, such as action usage information and/or application usage information, in contextual information data store 228.

Computing device 110 may determine a first, current context of computing device 110 at a first time (502). Computing device 110 may determine the first context in response to a triggering event (e.g., receiving a user input to wake or unlock computing device 110, detecting an unauthorized individual proximate to computing device 110, receiving an explicit user input to determine the current context, etc.), in response to determining the state of one or more application changed (e.g., upon executing or ceasing to execute an application module 124), or at periodic time intervals (e.g., every 15 minutes). The context at the first time may include the location of computing device 110 at the first time, the date, time, whether individuals other than an individual associated with the active user account are proximate to computing device, etc.

Computing device 110 may determine a similarity score indicative of a similarity between the first context and a second context of computing device 110 at a second time (504). Computing device 110 may determine the similarity score based on the one or more portions of contextual information for the context at the first time and the context at the second time. For example, computing device 110 may assign a relative high similarity score if the location of computing device 110 at the first time is at the same as the location of computing device 110 at the second time, a medium similarity score if the locations at the first time and the second time are similar but not the same (e.g., different coffee shops), and a relatively low similarity score if the locations are not the same type. As another example, computing device 110 may assign a higher similarity score if the time of day at the first time is similar to the time of day at the second time (e.g., between 9 am and noon). Computing device 110 may weigh various portions of contextual information equally in determining the similarity score. In some instances, however, computing device 110 may assign different weights to the various portions of contextual information.

Computing device 110 determine whether the similarity score satisfies a similarity threshold (506). In some examples, computing devices 110 determines the similarity score satisfies the similarity threshold when the similarity score is greater than or equal to the similarity threshold.

Responsive to determining that the similarity score satisfies the similarity threshold (“YES” branch of 506), computing device 110 may determine one or more application that were executing at the second time and the respective state of each application that was executing at the second time (508). For example, computing device 110 may query contextual information data store 228 of FIG. 2. The query may return results indicating the applications that were executing the second time and the state of each application at the second time.

Computing device 110 may execute at least one of the one or more application that were executing at the second time (510). For example, computing device 110 may, at the first time, restart an application that was executing at the earlier second time but was not executing at some intermediate time between the first time and the second time. Computing device 110 may restore each of the at least one application to the respective state that existed at the second time (512). For example, computing device 110 may restore an internet browser to its prior state by opening the web browser to a particular webpage that was open at the second time or may restore an email application by signing into a particular email account that was signed in at the second time.

Responsive to determining the similarity score does not satisfy the similarity threshold (“NO” branch of 506), computing device 110 may refrain from restoring one or more applications to the respective state that existed at the second time (514). In some instances, computing device 110 may also suppress one or more activities that were being performed by one or more application modules 124 at a time between the current first time and the previous second time. For example, computing device 110 may cease executing one or more application that were running prior to the first time, refraining from outputting a graphical interface associated with an application that was running prior to the first time (e.g., by minimizing an application window), or otherwise refraining from resuming one or more activities and/or applications.

The following numbered examples may illustrate one or more aspects of the disclosure:

### Example 1

A method comprising: determining, by one or more processors, a first context of a computing device including a location of the computing device at a first time, determining, by the one or more processors, a similarity score indicative of a similarity between the first context and a second context of the computing device, the second context including a location of the computing device at a second time that is earlier than the first time; determining, by the one or more processors, whether the similarity score satisfies a similarity threshold; and responsive to determining the similarity score satisfies the similarity threshold: determining, by the one or more processors, one or more applications that were executing at the second time and a respective state of each of the one or more applications at the second time; executing, by the one or more processors, at least one of the one or more applications; and restoring, by the one or more processors, the respective state of each of the at least one of the one or more applications.

### Example 2

The method of example 1, further comprising, responsive to determining the similarity score satisfies the similarity threshold: determining, by the one or more processors, one or more activities that were being performed by one or more applications at a third time and that were not being performed at the second time, wherein the third time occurred between the first time and the second time; and suppressing, by the one or more processors, at least one of the one or more activities.

### Example 3

The method of any combination of examples 1-2, wherein: the at least one application was not executing at a third time that occurred between the first time and the second time, or the state of the at least one application at the third time was different than the state of the at least one application at the second time.

### Example 4

The method of any combination of examples 1-3, wherein determining whether the similarity score satisfies the similarity threshold is responsive to receiving a user input to unlock the computing device.

### Example 5

The method of example 4, further comprising: responsive to receiving the user input to unlock the computing device and prior to unlocking the computing device, outputting, by the one or more processors, an indication of the one or more applications that were executing at the second time, wherein executing at least one of the one or more applications is responsive to receiving, by the one or more processors, a user input selecting the at least one of the one or more applications.

### Example 6

The method of any combination of examples 1-5, further comprising: storing, by the one or more processors, for each context of a plurality of contexts associated with a currently active user account of the computing device, each context corresponding to a different, respective time, information indicative of each application that was executing at the respective time and information indicative of the state of each respective application at the respective time.

### Example 7

The method of any combination of examples 1-6, further comprising: determining, by the one or more processors, for each context in a plurality of contexts associated with a currently active user account of the computing device, a respective similarity score between the first context and each respective context in the plurality of contexts; and selecting, by the one or more processors, based on the respective similarity scores, a particular context in the plurality of contexts as the second context.

### Example 8

A computing device comprising: at least one processor; and at least one input device configured to provide information indicative of a location of the computing device to the at least one processor; a memory comprising instructions that, when executed by the at least one processor, cause the at least one processor to: determine, based at least in part on the information indicative of the location of the computing device, the location of the computing device at a first time; determine, a first context of the computing device including a location of the computing device at the first time, determine a similarity score indicative of a similarity between the first context and a second context of the computing device, the second context including a location of the computing device at a second time that is earlier than the first time; determine whether the similarity score satisfies a similarity threshold; and responsive to determining the similarity score satisfies the similarity threshold: determine one or more applications that were executing at the second time and a respective state of each of the one or more applications at the second time; execute at least one of the one or more applications; and restore the respective state of each of the at least one of the one or more applications.

### Example 9

The computing device of example 8, wherein the instructions further cause the at least one processor to, further responsive to determining the similarity score satisfies the similarity threshold: determine one or more activities that were being performed by one or more applications at a third time and were not being performed at the second time, wherein the third time occurred between the first time and the second time; and suppress at least one of the one or more activities.

### Example 10

The computing device of any combination of examples 8-9, wherein: the at least one application was not executing at a third time that occurred between the first time and the second time, or the state of the at least one application at the third time was different than the state of the at least one application at the second time.

### Example 11

The computing device of any combination of examples 8-10, wherein the instructions further cause the at least one processor to determine whether the similarity score satisfies the similarity threshold in response to receiving a user input to unlock the computing device.

### Example 12

The computing device of example 11, further comprising a display device, wherein the instructions further cause the at least one processor to: responsive to receiving the user input to unlock the computing device and prior to unlocking the computing device, output, for display at the display device, an indication of the one or more applications that were executing at the second time, and execute at least one of the one or more applications in response to receiving a user input selecting the at least one of the one or more applications.

### Example 13

The computing device of any combination of examples 8-12, wherein the instructions further cause the at least one processor to: store for each context of a plurality of contexts associated with a currently active user account of the computing device, each context corresponding to a different, respective time, information indicative of each application that was executing at the respective time and information indicative of the state of each respective application at the respective time.

### Example 14

The computing device of any combination of examples 8-13, wherein the instructions further cause the at least one processor to: determine for each context in a plurality of contexts associated with a currently active user account of the computing device, a respective similarity score between the first context and each respective context in the plurality of contexts; and select based on the respective similarity scores, a particular context in the plurality of contexts as the second context.

### Example 15

A non-transitory computer-readable storage medium encoded with instructions that, when executed by at least one processor of a computing device, cause the at least one processor to: determine, a first context of the computing device including a location of the computing device at a first time, determine a similarity score indicative of a similarity between the first context and a second context of the computing device, the second context including a location of the computing device at a second time that is earlier than the first time; determine whether the similarity score satisfies a similarity threshold; and responsive to determining the similarity score satisfies the similarity threshold: determine one or more applications that were executing at the second time and a respective state of each of the one or more applications at the second time; execute at least one of the one or more applications; and restore the respective state of each of the at least one of the one or more applications.

### Example 16

The non-transitory computer-readable storage medium of example 15, wherein the computer-readable storage medium comprises additional instructions that cause the at least one processor to, further responsive to determining the similarity score satisfies the similarity threshold: determine one or more activities that were being performed by one or more applications at a third time and were not being performed at the second time, wherein the third time occurred between the first time and the second time; and suppress at least one of the one or more activities.

### Example 17

The non-transitory computer-readable storage medium of any combination of examples 15-16, wherein: the at least one application was not executing at a third time that occurred between the first time and the second time, or the state of the at least one application at the third time was different than the state of the at least one application at the second time.

### Example 18

The non-transitory computer-readable storage medium of any combination of examples 15-17, wherein the computer-readable storage medium comprises additional instructions that cause the at least one processor to determine whether the similarity score satisfies the similarity threshold in response to receiving a user input to unlock the computing device.

### Example 19

The non-transitory computer-readable storage medium of example 18, wherein the computer-readable storage medium comprises additional instructions that cause the at least one processor to: responsive to receiving the user input to unlock the computing device and prior to unlocking the computing device, output, for display at a display device, an indication of the one or more applications that were executing at the second time, and execute at least one of the one or more applications in response to receiving a user input selecting the at least one of the one or more applications.

### Example 20

The non-transitory computer-readable storage medium of any combination of examples 15-19, wherein the computer-readable storage medium comprises additional instructions that cause the at least one processor to: store for each context of a plurality of contexts associated with a currently active user account of the computing device, each context corresponding to a different, respective time, information indicative of each application that was executing at the respective time and information indicative of the state of each respective application at the respective time.

### Example 21

The non-transitory computer-readable storage medium of any combination of examples 15-20, wherein the computer-readable storage medium comprises additional instructions that cause the at least one processor to: determine for each context in a plurality of contexts associated with a currently active user account of the computing device, a respective similarity score between the first context and each respective context in the plurality of contexts; and select based on the respective similarity scores, a particular context in the plurality of contexts as the second context.

### Example 22

A system comprising: means for determining a first context of a computing device including a location of the computing device at a first time, means for determining a similarity score indicative of a similarity between the first context and a second context of the computing device, the second context including a location of the computing device at a second time that is earlier than the first time; means for determining whether the similarity score satisfies a similarity threshold; and responsive to determining the similarity score satisfies the similarity threshold: means for determining one or more applications that were executing at the second time and a respective state of each of the one or more applications at the second time; means for executing at least one of the one or more applications; and means for restoring the respective state of each of the at least one of the one or more applications.

### Example 23

The system of example 22, further comprising, responsive to determining the similarity score satisfies the similarity threshold: means for determining one or more activities that were being performed by one or more applications at a third time and that were not being performed at the second time, wherein the third time occurred between the first time and the second time; and means for suppressing at least one of the one or more activities.

### Example 24

The method of any combination of examples 22-23, wherein: the at least one application was not executing at a third time that occurred between the first time and the second time, or the state of the at least one application at the third time was different than the state of the at least one application at the second time.

### Example 25

The method of any combination of examples 22-24, wherein determining whether the similarity score satisfies the similarity threshold is responsive to receiving a user input to unlock the computing device.

### Example 26

The method of example 25, further comprising: responsive to receiving the user input to unlock the computing device and prior to unlocking the computing device, means for outputting an indication of the one or more applications that were executing at the second time, wherein executing at least one of the one or more applications is responsive to receiving a user input selecting the at least one of the one or more applications.

### Example 27

The method of any combination of examples 22-26, further comprising: means for storing for each context of a plurality of contexts associated with a currently active user account of the computing device, each context corresponding to a different, respective time, information indicative of each application that was executing at the respective time and information indicative of the state of each respective application at the respective time.

### Example 28

The method of any combination of examples 22-27, further comprising: means for determining for each context in a plurality of contexts associated with a currently active user account of the computing device, a respective similarity score between the first context and each respective context in the plurality of contexts; and means for selecting, based on the respective similarity scores, a particular context in the plurality of contexts as the second context.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
determining, by one or more processors, a first context of a computing device including a location of the computing device at a first time,
determining, by the one or more processors, a similarity score indicative of a similarity between the first context and a second context of the computing device, the second context including a location of the computing device at a second time that is earlier than the first time;
determining, by the one or more processors, whether the similarity score satisfies a similarity threshold; and
responsive to determining the similarity score satisfies the similarity threshold:
determining, by the one or more processors, one or more applications that were executing at the second time and a respective state of each of the one or more applications at the second time;
executing, by the one or more processors, at least one of the one or more applications; and
restoring, by the one or more processors, the respective state of each of the at least one of the one or more applications.

2. The method of claim 1, further comprising, responsive to determining the similarity score satisfies the similarity threshold:
determining, by the one or more processors, one or more activities that were being performed by one or more applications at a third time and that were not being performed at the second time, wherein the third time occurred between the first time and the second time; and
suppressing, by the one or more processors, at least one of the one or more activities.

3. The method of claim 1, wherein:
the at least one application was not executing at a third time that occurred between the first time and the second time, or
the state of the at least one application at the third time was different than the state of the at least one application at the second time.

4. The method of claim 1, wherein determining whether the similarity score satisfies the similarity threshold is responsive to receiving a user input to unlock the computing device.

5. The method of claim 4, further comprising:
responsive to receiving the user input to unlock the computing device and prior to unlocking the computing device, outputting, by the one or more processors, an indication of the one or more applications that were executing at the second time,
wherein executing at least one of the one or more applications is responsive to receiving, by the one or more processors, a user input selecting the at least one of the one or more applications.

6. The method of claim 1, further comprising:
storing, by the one or more processors, for each context of a plurality of contexts associated with a currently active user account of the computing device, each context corresponding to a different, respective time, information indicative of each application that was executing at the respective time and information indicative of the state of each respective application at the respective time.

7. The method of claim 1, further comprising:
determining, by the one or more processors, for each context in a plurality of contexts associated with a currently active user account of the computing device, a respective similarity score between the first context and each respective context in the plurality of contexts; and
selecting, by the one or more processors, based on the respective similarity scores, a particular context in the plurality of contexts as the second context.

8. A computing device comprising:
at least one processor; and
at least one input device configured to provide information indicative of a location of the computing device to the at least one processor;
a memory comprising instructions that, when executed by the at least one processor, cause the at least one processor to:
determine, based at least in part on the information indicative of the location of the computing device, the location of the computing device at a first time;
determine, a first context of the computing device including a location of the computing device at the first time,
determine a similarity score indicative of a similarity between the first context and a second context of the computing device, the second context including a location of the computing device at a second time that is earlier than the first time;
determine whether the similarity score satisfies a similarity threshold; and
responsive to determining the similarity score satisfies the similarity threshold:
determine one or more applications that were executing at the second time and a respective state of each of the one or more applications at the second time;
execute at least one of the one or more applications; and
restore the respective state of each of the at least one of the one or more applications.

9. The computing device of claim 8, wherein the instructions further cause the at least one processor to, further responsive to determining the similarity score satisfies the similarity threshold:
determine one or more activities that were being performed by one or more applications at a third time and were not being performed at the second time, wherein the third time occurred between the first time and the second time; and
suppress at least one of the one or more activities.

10. The computing device of claim 8, wherein:
the at least one application was not executing at a third time that occurred between the first time and the second time, or
the state of the at least one application at the third time was different than the state of the at least one application at the second time.

11. The computing device of claim 8, wherein the instructions further cause the at least one processor to determine whether the similarity score satisfies the similarity threshold in response to receiving a user input to unlock the computing device.

12. The computing device of claim 11, further comprising a display device, wherein the instructions further cause the at least one processor to:
responsive to receiving the user input to unlock the computing device and prior to unlocking the computing device, output, for display at the display device, an indication of the one or more applications that were executing at the second time, and
execute at least one of the one or more applications in response to receiving a user input selecting the at least one of the one or more applications.

13. The computing device of claim 8, wherein the instructions further cause the at least one processor to:
store for each context of a plurality of contexts associated with a currently active user account of the computing device, each context corresponding to a different, respective time, information indicative of each application that was executing at the respective time and information indicative of the state of each respective application at the respective time.

14. The computing device of claim 8, wherein the instructions further cause the at least one processor to:
determine for each context in a plurality of contexts associated with a currently active user account of the computing device, a respective similarity score between the first context and each respective context in the plurality of contexts; and
select based on the respective similarity scores, a particular context in the plurality of contexts as the second context.

15. A non-transitory computer-readable storage medium encoded with instructions that, when executed by at least one processor of a computing device, cause the at least one processor to:
determine, a first context of the computing device including a location of the computing device at a first time,
determine a similarity score indicative of a similarity between the first context and a second context of the computing device, the second context including a location of the computing device at a second time that is earlier than the first time;
determine whether the similarity score satisfies a similarity threshold; and
responsive to determining the similarity score satisfies the similarity threshold:
determine one or more applications that were executing at the second time and a respective state of each of the one or more applications at the second time;
execute at least one of the one or more applications; and
restore the respective state of each of the at least one of the one or more applications.

16. The non-transitory computer-readable storage medium of claim 15, wherein the computer-readable storage medium comprises additional instructions that cause the at least one processor to, further responsive to determining the similarity score satisfies the similarity threshold:
determine one or more activities that were being performed by one or more applications at a third time and were not being performed at the second time, wherein the third time occurred between the first time and the second time; and
suppress at least one of the one or more activities.

17. The non-transitory computer-readable storage medium of claim 15, wherein:
the at least one application was not executing at a third time that occurred between the first time and the second time, or
the state of the at least one application at the third time was different than the state of the at least one application at the second time.

18. The non-transitory computer-readable storage medium of claim 15, wherein the computer-readable storage medium comprises additional instructions that cause the at least one processor to determine whether the similarity score satisfies the similarity threshold in response to receiving a user input to unlock the computing device.

19. The non-transitory computer-readable storage medium of claim 18, wherein the computer-readable storage medium comprises additional instructions that cause the at least one processor to:
responsive to receiving the user input to unlock the computing device and prior to unlocking the computing device, output, for display at a display device, an indication of the one or more applications that were executing at the second time, and
execute at least one of the one or more applications in response to receiving a user input selecting the at least one of the one or more applications.

20. The non-transitory computer-readable storage medium of claim 15, wherein the computer-readable storage medium comprises additional instructions that cause the at least one processor to:
determine for each context in a plurality of contexts associated with a currently active user account of the computing device, a respective similarity score between the first context and each respective context in the plurality of contexts; and
select based on the respective similarity scores, a particular context in the plurality of contexts as the second context.
